(19) United States
(12) Patent Application Publication
(10) Pub. No.: US 2013/0242212 A1
(43) Pub. Date: Sep. 19, 2013

(54) MIRROR SWITCHABLE ORGANIC LIGHT EMITTING DISPLAY AND MIRROR SWITCHABLE DISPLAY

(71) Applicants: Yu-Chun Huang, Taoyuan County (TW); Chia-Chun Chang, Taoyuan County (TW)

(72) Inventors: Yu-Chun Huang, Taoyuan County (TW); Chia-Chun Chang, Taoyuan County (TW)

(73) Assignee: AU OPTRONICS CORPORATION, Hsinchu (TW)

(21) Appl. No.: 13/480,440

(22) Filed: May 24, 2012

(30) Foreign Application Priority Data
Mar. 16, 2012 (TW) 101109091

(51) Int. Cl. G02F 1/1335; H05B 33/12

(52) U.S. Cl. 349/15; 313/504

(57) ABSTRACT

A mirror switchable organic light emitting display includes an organic light emitting display panel, a switchable quarter-wave phase retardation panel, a light transflective layer, and a polarizing plate. The organic light emitting display panel has a light output surface. The switchable quarter-wave phase retardation panel having a first surface and a second surface, is disposed at the light output surface of the organic light emitting display panel, wherein the first surface faces the organic light emitting display panel. The light transflective layer is disposed at the first surface of the quarter-wave phase retardation panel and faces the organic light emitting display panel. The polarizing plate is disposed on the second surface of the quarter-wave phase retardation panel.

### CROSS-REFERENCE TO RELATED APPLICATION

This application claims the priority benefit of Taiwan application serial no. 101109091, filed on Mar. 16, 2012. The entirety of the above-mentioned patent application is hereby incorporated by reference herein and made a part of this specification.

### BACKGROUND OF THE INVENTION

1. Field of the Invention

The invention relates to a display, and more particularly to a minor switchable display.

2. Description of Related Art

Among the displays, organic light emitting display is a self-illuminating screen, and has the greatest potential to become the major display product in the next generation, with the advantages including wide viewing angle, low power consumption, simple manufacturing process, low cost, a wide operating temperature range, a high response speed and full-color display.

In general, the ambient light is reflected by the surface of the organic light emitting display, and thus the organic light emitting display is not able to display a black image to the viewer in the general environment, especially in the bright light environment. This problem can be solved by disposing the circular polarizing plate which includes the liner polarizing plate and the λ/4 phase retardation plate. In detail, when the ambient light passes through the liner polarizing plate, half of the energy of the ambient light is absorbed and the remaining ambient light is then polarized by the liner polarizing plate. After that, the polarized ambient light is converted to a dextrorotary light when passing through the λ/4 phase retardation plate, and is further polarized when passing through the λ/4 phase retardation plate again. Therefore, a polarized angle between the converted ambient light and the ambient light only passing through the liner polarizing plate is 90 degrees, and the converted ambient light is blocked by the liner polarizing plate and can not be transmitted into the display. Accordingly, the reflection of the ambient light at the surface of the display is eliminated.

However, the circular polarizing plate in the current organic light emitting display can not be turned on or turned off selectively, that is, can not be switched between λ/4 phase retardation and zero phase retardation. Thus, the application of the organic light emitting display is limited.

### SUMMARY OF THE INVENTION

The invention provides a mirror switchable organic light emitting display that is switchable between an image display mode and a mirror mode.

The invention further provides a mirror switchable display that is switchable between an image display mode and a mirror mode.

The invention is directed to a mirror switchable organic light emitting display including an organic light emitting display panel, a switchable quarter-wave phase retardation panel, a light transflective layer, and a polarizing plate. The organic light emitting display panel has a light output surface. The switchable quarter-wave phase retardation panel is disposed at the light output surface of the organic light emitting display panel, and has a first surface and a second surface, wherein the first surface faces the organic light emitting display panel. The light transflective layer is disposed at the first surface of the quarter-wave phase retardation panel and faces the organic light emitting display panel. The polarizing plate is disposed on the second surface of the quarter-wave phase retardation panel.

The invention is further directed to a mirror switchable display including an active light emitting display panel, a switchable quarter-wave phase retardation panel, a light transflective layer, and a polarizing plate. The active light emitting display panel has a light output surface. The switchable quarter-wave phase retardation panel has a first surface and a second surface, wherein the first surface faces the active light emitting display panel. The light transflective layer is disposed at the first surface of the quarter-wave phase retardation panel and faces the active light emitting display panel. The polarizing plate is disposed on the second surface of the quarter-wave phase retardation panel.

Based on the above, the mirror switchable organic light emitting display and the mirror switchable display of the invention have phase retardation panels which can be switched between λ/4 phase retardation and zero phase retardation. Thus, the display is switchable between an image display mode and a mirror mode, or simultaneously provides mirror area and image area at different regions therein. Furthermore, in the image display mode, since the phase retardation panel can reduce the interference of the incident light to the display, the display has superior display effect. On the other hand, in the mirror mode, the light transflective layer disposed at a side surface of the phase retardation panel is able to increase the reflection of the incident light, and thus the display also has superior mirror effect. In addition, since the light transflective layer is disposed at the first surface of the quarter-wave phase retardation panel, the reflection of the incident light is increased and the scattering of the incident light is reduced, and the display provides improved mirror effect when in the mirror mode.

In order to make the aforementioned properties and advantages of the invention more comprehensible, embodiments accompanied with figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic cross-sectional view illustrating a mirror switchable organic light emitting display according to an embodiment of the invention.

FIG. 2 is a schematic cross-sectional view illustrating a mirror switchable organic light emitting display according to another embodiment of the invention.

FIG. 3A is a schematic view illustrating λ/4 phase retardation effect generated by the switchable quarter-wave phase retardation panel of the mirror switchable organic light emitting display.

FIG. 3B is a schematic view illustrating 0 phase retardation effect generated by the switchable quarter-wave phase retardation panel of the mirror switchable organic light emitting display.

FIG. 4A is a schematic cross-sectional view illustrating a mirror switchable organic light emitting display according to an embodiment of the invention.

FIG. 4B is a schematic top view illustrating a mirror switchable organic light emitting display according to an embodiment of the invention.

FIG. 5 is a schematic cross-sectional view illustrating a mirror switchable display according to an embodiment of the invention.

### DETAILED DESCRIPTION OF THE EMBODIMENTS

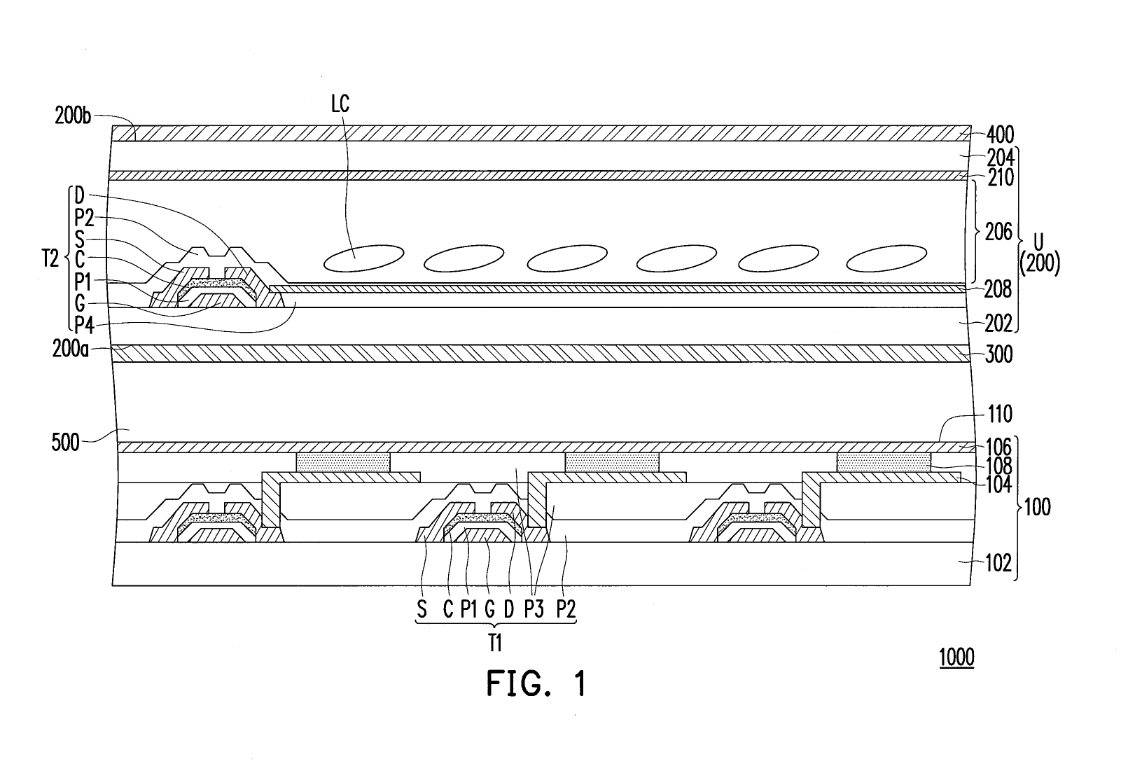

FIG. 1 is a schematic cross-sectional view illustrating a mirror switchable organic light emitting display according to an embodiment of the invention. The mirror switchable organic light emitting display 1000 includes an organic light emitting display panel 100, a switchable quarter-wave (λ/4) phase retardation panel 200, a light transflective layer 300, and a polarizing plate 400.

In the present embodiment, the organic light emitting display panel 100 includes a substrate 102, a first electrode 104, a second electrode 106, and an organic light emitting layer 108. The substrate 102 can be made of a light-transmissive material, a non-light-transmissive material, a reflective material (such as a conductive material, metal, wafer, ceramics, or the like), or other suitable materials. The light-transmissive material can be glass, quartz, an organic polymer, or other suitable materials.

The first electrode 104 is disposed on the substrate 102, for instance. In the present embodiment, a material of the first electrode 104 can be a transparent conductive material, or a non-transparent conductive material. The transparent conductive material includes metal oxide, such as indium tin oxide (ITO), indium zinc oxide (IZO), aluminum tin oxide (ATO), aluminum zinc oxide (AZO), indium germanium zinc oxide, other suitable oxide, or a stacked layer having at least two of the above materials. The non-transparent conductive material includes metal.

The second electrode 106 is disposed above the first electrode 104. In the present embodiment, the second electrode 106 can be a patterned electrode or an unpatterned electrode, and a material thereof can be a transparent conductive material or a non-transparent conductive material. The transparent conductive material includes metal oxide, such as indium tin oxide (ITO), indium zinc oxide (IZO), aluminum tin oxide (ATO), aluminum zinc oxide (AZO), indium germanium zinc oxide, other suitable oxide, or a stacked layer having at least two of the above materials. The non-transparent conductive material includes metal.

Generally, one of the first electrode 104 and the second electrode 106 is served as an anode of the organic light emitting display panel 100, and the other one is served as a cathode of the organic light emitting display panel 100. In the present embodiment, the first electrode 104 is an anode, for instance, and the second electrode 106 is a cathode, for instance.

The organic light emitting layer 108 is disposed between the first electrode 104 and the second electrode 106. Here, the organic light emitting layer 108 may include a red organic light emitting pattern layer, a green organic light emitting pattern layer, a blue organic light emitting pattern layer, a light emitting pattern layer with other colors, or a combination of the aforesaid light emitting pattern layers. Besides, according to other embodiments, the organic light emitting layer 108 may further include an electron transmission layer, an electron injection layers, a hole transmission layer, a hole injection layer, or a combination of the aforesaid layers(not shown), which is well known to the one skilled in the art and the detailed description is omitted.

In the present embodiment, the organic light emitting display panel 100 may further include a thin film transistor T1, disposed on the substrate 102 and electrically connecting to the first electrode 104. According to the present embodiment, the thin film transistor T1 includes a gate electrode G, a channel layer C, a source electrode S, a drain electrode D, a dielectric layer P1, a passivation layer P2, and a planar layer P3, for instance. The gate electrode G is, for instance, disposed on the substrate 102. The channel layer C is, for instance, disposed on the dielectric layer P1 above the gate electrode G. The source electrode S and the drain electrode D are disposed on the relative sides of the channel layer C above the gate electrode G, for example. The passivation layer P2 covers the source electrode S, the drain electrode D, and the dielectric layer P1, for instance. The planar layer P3 covers the passivation layer P2. In the present embodiment, the first electrode 104 is, for instance, served as a pixel electrode of the thin film transistor T1. The first electrode 104 is formed on the planar layer P3 and electrically connected to the drain electrode D through the openings in the planar layer P3 and the passivation layer P2, so as to be electrically connected to the thin film transistor T1, for instance.

It is mentioned that although the bottom gate thin film transistor is exemplified herein for the thin film transistor T1, but the invention is not limited to this. In other words, according to other embodiments, the organic light emitting display panel 100 may include, for example, a top-gate thin film transistor. Moreover, although the thin film transistor T1 is exemplified as shown in FIG. 1 herein, but the thin film transistor T1 may have other configurations.

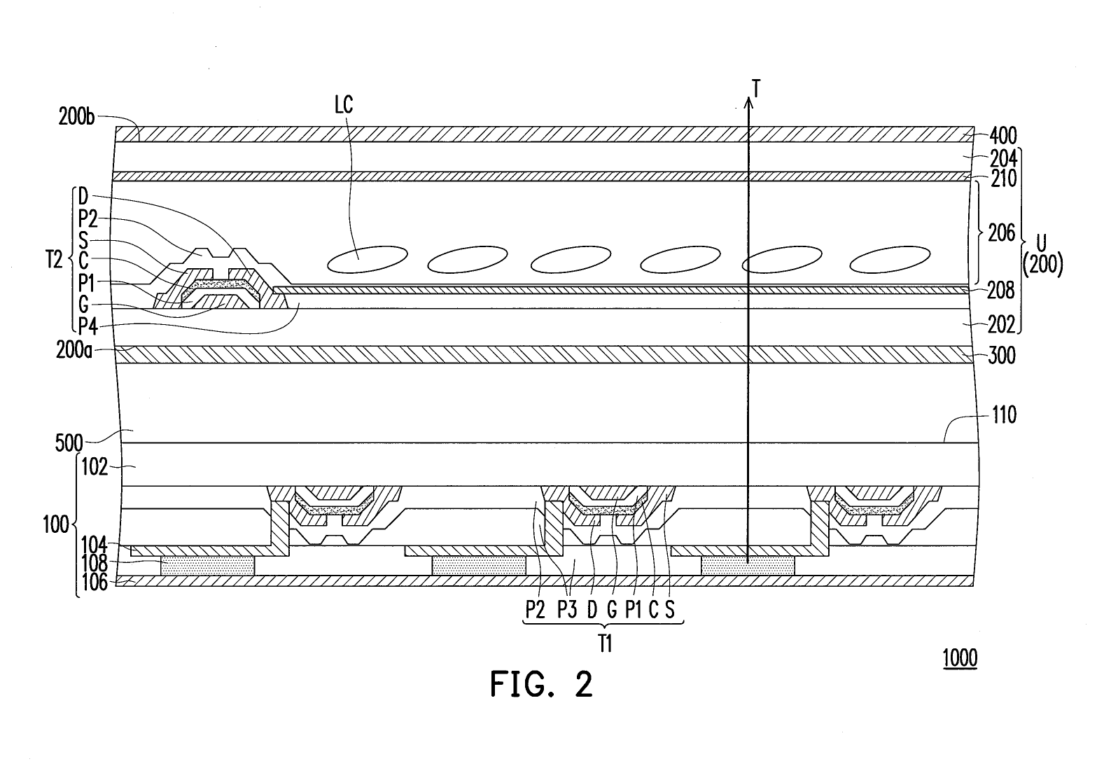

In the present embodiment, the organic light emitting display panel 100 is exemplified as a top emission organic light emitting display, and thus a material of the second electrode 106 includes a transparent conductive material, and the second electrode 106 is disposed at the light output surface 110 of the organic light emitting layer 108. That is to say, the transmission path of the light emitted by the organic light emitting layer 108 is from the first electrode 104 towards the second electrode 106, and therefore the second electrode 106 is disposed at the light output surface 110 of the organic light emitting layer 108. In another embodiment, as shown in FIG. 2, the organic light emitting display panel 100 may also be a bottom emission organic light emitting display, and thus the transmission path of the light emitted by the organic light emitting layer 108 is from the second electrode 106 towards the first electrode 104. Hence, a material of the first electrode 104 includes a transparent conductive material, for example, and the first electrode 104 is disposed at the light output surface 110 of the organic light emitting layer 108. Moreover, if the organic light emitting display panel 100 is a bottom emission organic light emitting display, the substrate 102 is required to apply a transparent material.

The switchable quarter-wave (λ/4) phase retardation panel 200 is disposed at the light output surface 110 of the organic light emitting display panel 100, and has a first surface 200a and a second surface 200b, wherein the first surface 200a faces the organic light emitting display panel 100. Based on the above, if the organic light emitting display panel 100 is a top emission organic light emitting display, the second electrode 106 is disposed at the light output surface 110 of the organic light emitting layer 108. Therefore, the switchable quarter-wave phase retardation panel 200 is, for instance, disposed at a side of the second electrode 106, which the side is corresponding to a side at which the organic light emitting layer 108 is disposed. In other words, the switchable quarter-wave phase retardation panel 200 and the organic light emitting layer 108 are disposed at two opposite sides of the second electrode 106, respectively. On the contrary, if the organic light emitting display panel 100 is a bottom emission organic light emitting display, the first electrode 104 is disposed at the light output surface 110 of the organic light emitting layer 108. Therefore, the switchable quarter-wave phase retardation panel 200 is, for instance, disposed at a side of the first electrode 104, which is corresponding to a side at which the organic light emitting layer 108 is disposed. That is to say, the switchable quarter-wave phase retardation panel 200 and the organic light emitting layer 108 are disposed at two opposite sides of the first electrode 104, respectively.

In the present embodiment, the switchable quarter-wave phase retardation panel 200 includes, for instance, a quarter-wave phase retardation unit U. The quarter-wave phase retardation unit U may include a first transparent substrate 202, a second transparent substrate 204, a liquid crystal layer 206, a first conductive layer 208, and a second conductive layer 210.

The second transparent substrate 204 is disposed opposite to the first transparent substrate 202, for instance. The first transparent substrate 202 and the second transparent substrate 204 can be made of glass, quartz, organic polymer, or any other appropriate material. A material of the first transparent substrate 202 and the second transparent substrate 204 can be the same or different, which is determined based on users' preference or requirements and should not be construed as a limitation to this invention.

The liquid crystal layer 206 is disposed between the first transparent substrate 202 and the second transparent substrate 204, for example. The liquid crystal layer 206 includes a plurality of liquid crystal molecules LC, wherein the liquid crystal molecules LC are optically anisotropic in the electrical field and optically isotropic when there is no electrical field. According to other embodiments, the liquid crystal layer 206 can also include spacers (not shown) which are used to maintain the thickness of the switchable quarter-wave phase retardation panel 200, and a material of the spacers can be an organic transparent insulated material or inorganic transparent insulated material.

The first conductive layer 208 is, for example, disposed on the first transparent substrate 202 and between the first transparent substrate 202 and the liquid crystal layer 206. The second conductive layer 210 is, for example, disposed on the second transparent substrate 204 and between the second transparent substrate 204 and the liquid crystal layer 206. In the present embodiment, a material of the first conductive layer 208 and the second conductive layer 210 can include a transparent conductive material. The transparent conductive material is indium tin oxide (ITO), indium zinc oxide (IZO), aluminum zinc oxide (AZO), the mixtures thereof or the stacked layers thereof, for example.

In the present embodiment, the switchable quarter-wave phase retardation panel 200 may further include an active device T2, disposed on the first transparent substrate 202 and electrically connected to the first conductive layer 208. The active device T2 is, for example, a thin film transistor, and includes a gate electrode G, a channel layer C, a source electrode S, a drain electrode D, dielectric layers P1 and P4, and a passivation layer P2, for instance. The gate electrode G, the channel layer C, the source electrode S, the drain electrode D, the dielectric layers P1 and P4, and the passivation layer P2 may be referred to as those described in the previous embodiment and thus will not be reiterated herein. The dielectric layer P4 is, for example, disposed on the first transparent substrate 202, and the first conductive layer 208 is disposed on the dielectric layer P4, for instance. In the present embodiment, the first conductive layer 208 is electrically connected to the active device T2 through the drain electrode D, for instance. Although a bottom gate thin film transistor is exemplified herein for the active device T2, but the present disclosure is not limited to this. In other words, according to other embodiments, the active device T2 may also be a top-gate thin film transistor or other type thin film transistors.

The light transflective layer 300 is disposed at the first surface 200a of the quarter-wave phase retardation panel 200 and faces the organic light emitting display panel 100. The light transflective layer 300 has both transmission and reflection properties to light. A material of the light transflective layer 300 can include aluminum, silver, platinum, copper, or gold, and thus mirror reflection is obtained when the incident light enters the light transflective layer 300. That is to say, by disposing the light transflective layer 300 at the first surface 200a of the quarter-wave phase retardation panel 200, the reflection of the incident light is increased and thus the display may provide superior mirror effect. In the present embodiment, a thickness of the light transflective layer 300 ranges from 1 to 1000 nm. Moreover, the light transflective layer 300 may also include a refractive index-matching layer (not shown), so as to increase the probability of reflection. Moreover, the light transflective layer 300 can also be made of a plurality of films, to achieve transflective effect by total reflection. Since the light transflective layer 300 is separately disposed, the light transflective layer 300 with superior transflective properties can be used to meet the requirements of mirror reflection. In addition, since the light transflective layer 300 is disposed at the first surface 200a of the quarter-wave phase retardation panel 200, the reflection of the incident light is increased and the scattering of the incident light is reduced, and thus the display provides superior mirror effect when in the mirror mode.

The polarizing plate 400 is disposed on the second surface 200b of the quarter-wave phase retardation panel 200. In the present embodiment, the polarizing plate 400 can include a liner polarizing plate. The polarizing plate 400 may polarize the incident light.

According to the present embodiment, the mirror switchable organic light emitting display 1000 further includes, for instance, a light-transmissive material layer 500 which is disposed between the light transflective layer 300 and the organic light emitting display panel 100. Therefore, the transmitted light emitted from the organic light emitting display panel 100 can pass the light-transmissive material layer 500 and the light transflective layer 300, so as to display an image. Accordingly, the light transflective layer 300 can be not entirely contact with the second electrode 106. The light-transmissive material layer 500 may be an adhesive layer, a spacing layer, a package layer, other layers, or a combination thereof. The adhesive layer can be a transparent insulated material, the spacing layer may be photoresist spacers, and the package layer may be a transparent package material, sealant, sealing glass, sealing gas such as inert gas or residue gas after being vacuumed, or a combination thereof. For example, the photoresist spacers may be selectively disposed between the light transflective layer 300 and the organic light emitting display panel 100, the sealant or sealing glass may surround the outer of the interface between the light transflective layer 300 and the organic light emitting display panel 100, and the residue gas is left in the space between the light transflective layer 300 and the organic light emitting display panel 100 after the space being vacuumed. In addition, the adhesive layer may also be entirely adhered to the light transflective layer 300 and the organic light emitting display panel 100, and so as to secure them. A low refractive material may be used to form the light-transmissive material layer 500, so as to increase the mirror reflection effect of the light transflective layer 300. The detail configuration of the light-transmissive material layer 500 is determined based on users' preference or requirements and should not be construed as a limitation to this invention.

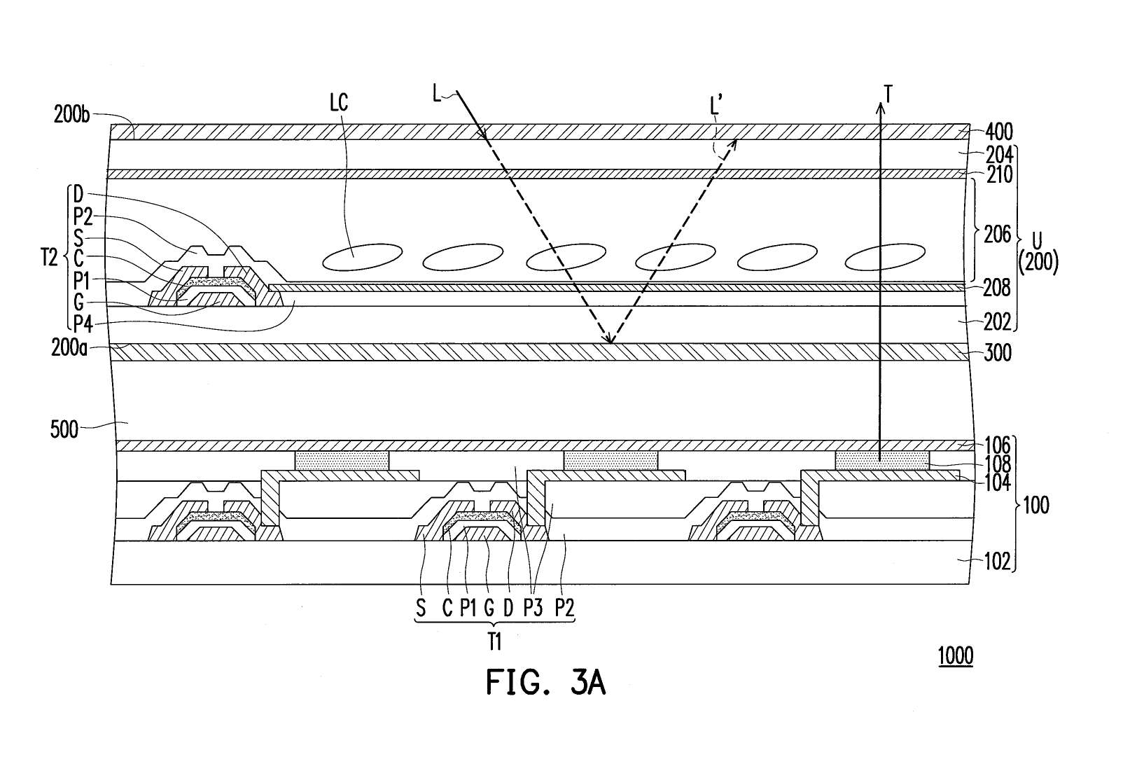

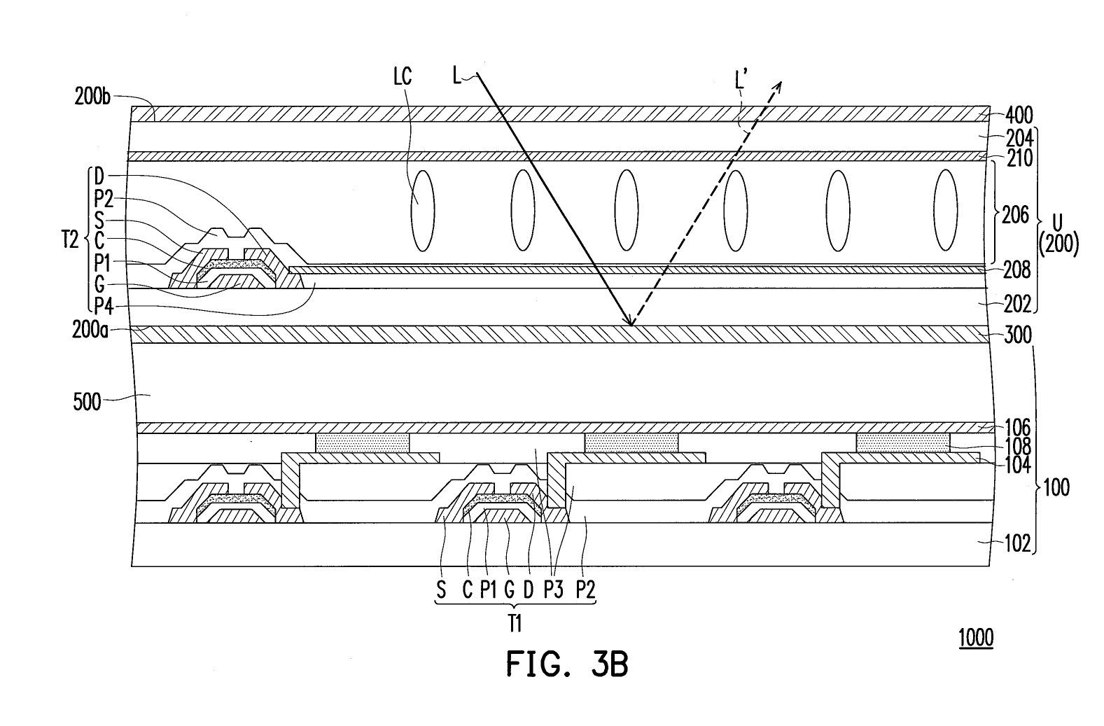

The mechanism of switching between λ/4 phase and 0 phase by the mirror switchable organic light emitting display 1000 is described below with reference to the figures. FIGS. 3A and 3B are respectively schematic views illustrating λ/4 phase retardation effect and 0 phase retardation effect generated by the switchable quarter-wave phase retardation panel 200 of the mirror switchable organic light emitting display 1000 in the image display mode and the mirror mode. Referring to FIG. 3A, in the image display mode, when a voltage difference between the first conductive layer 208 and the second conductive layer 210 is zero or there is no voltage applied to the first conductive layer 208 and the second conductive layer 210, the liquid crystal molecules LC in the liquid crystal layer 206 are in a horizontal state, and thus λ/4 phase retardation effect is generated. In detail, an incident light L is, for example, an ambient light, the incident light L is polarized by the polarizing plate 400 when the incident light L passes through the mirror switchable organic light emitting display 1000, and then is converted to a levorotatory light by the switchable quarter-wave phase retardation panel 200. After that, the levorotatory light is converted to a dextrorotary light (referred as a reflective light L′) by the light transflective layer 300, and is further polarized when passing through the switchable quarter-wave phase retardation panel 200 again. Comparing the reflective light L′ and the incident light L, a polarized angle therebetween is 90 degrees, and the reflective light L′ is blocked by the polarizing plate 400 and can not be transmitted into the mirror switchable organic light emitting display 1000. As a result, the reflective light L′ is eliminated, and the mirror switchable organic light emitting display 1000 displays a black image. At this time, a transmitted light T is emitted from organic light emitting display panel 100, and passing through the light transflective layer 300 and the quarter-wave phase retardation panel 200, thereby forming an image.

Referring to FIG. 3B, in the mirror mode, when a voltage is applied to the first conductive layer 208 or the second conductive layer 210, or the first conductive layer 208 and the second conductive layer 210 have a voltage difference, the liquid crystal molecules LC in the liquid crystal layer 206 are in a vertical state, and thus λ/4 phase retardation effect is turned off. Thus, 0 phase retardation is provided by the quarter-wave phase retardation panel 200. In detail, after the ambient light L enters the mirror switchable organic light emitting display 1000, the polarized incident light L directly passes through the quarter-wave phase retardation panel 200 and the polarized state thereof is not changed. Then, the polarized incident light L is reflected by the light transflective layer 300, and a reflective light L′, which has the same polarized direction as the polarized incident light L, is formed. The reflective light L′ is able to directly pass through the switchable quarter-wave phase retardation panel 200 to the polarizing plate 400, and is then further polarized and emitted. As a result, the mirror switchable organic light emitting display 1000 provides mirror reflection effect.

In the present embodiment, the mirror switchable organic light emitting display 1000 can be switched between λ/4 phase retardation and 0 phase retardation, and thus is switchable between an image display mode and a mirror mode. As a result, the interference to the display caused by the incident light is decreased, and thereby the display has favorable display effect.

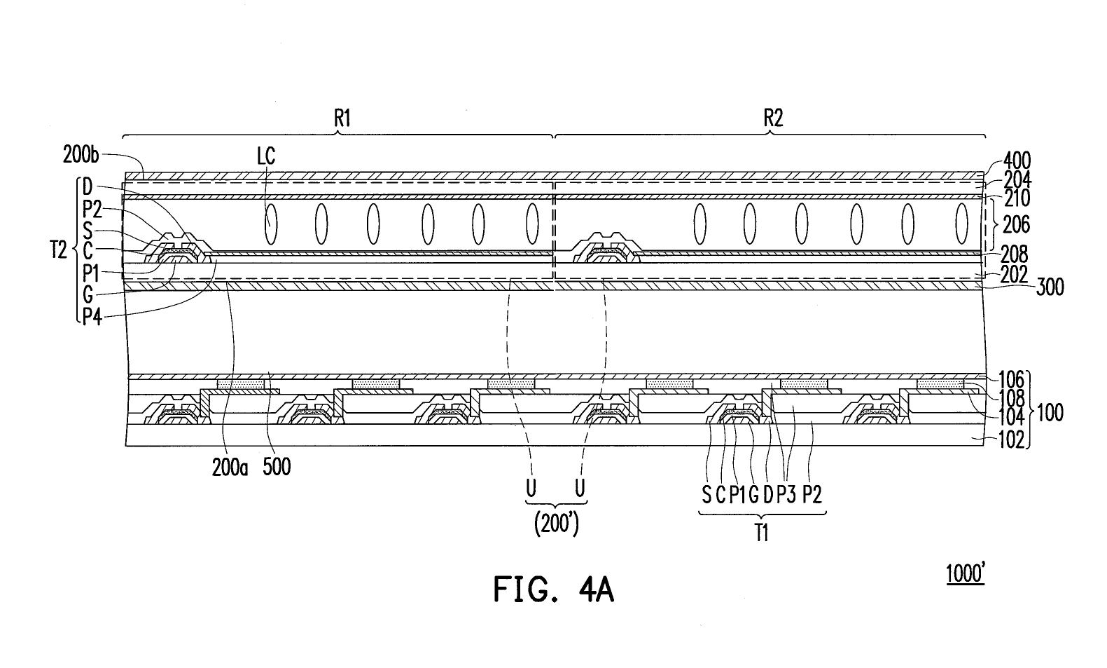

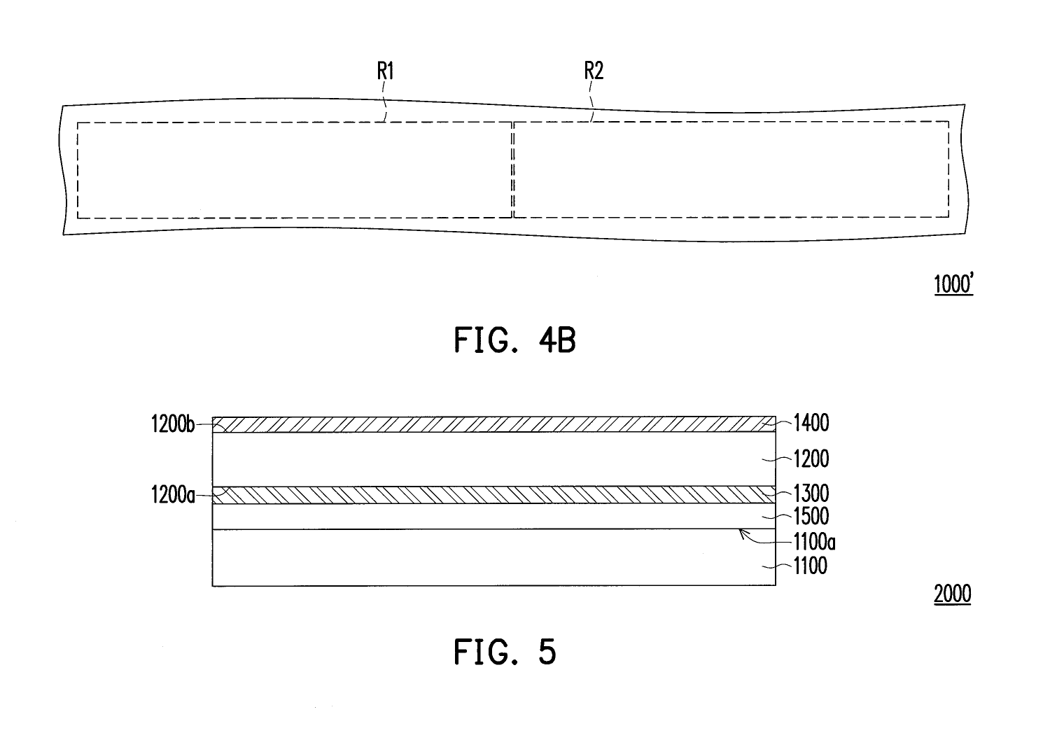

FIGS. 4A and 4B are respectively schematic cross-sectional view and schematic top view of illustrating a mirror switchable organic light emitting display according to an embodiment of the invention. Referring to FIGS. 4A and 4B, according to the present embodiment, the configuration of the mirror switchable organic light emitting display 1000′ is similar to that of the mirror switchable organic light emitting display 1000, while the difference therebetween lies in the switchable quarter-wave phase retardation panel 200′ has a plurality of switchable regions R. A switchable unit U is disposed in each switchable region R. Details about the switchable unit U can be referred to the switchable unit U in the aforementioned embodiment and are not reiterated herein. The switchable regions R are arranged in array, and thus the switchable units U are also arranged in array, for example. It should be noted that in FIG. 4A, the switchable quarter-wave phase retardation panel 200′ is exemplified as having 2 switchable regions R1 and R2, while the invention is not limited thereto. In other words, according to other embodiments, the switchable quarter-wave phase retardation panel 200′ can have more than 2 switchable regions R.

The switchable units U can be controlled by the same circuit or different circuits. Thus, each switchable unit U can respectively provide λ/4 phase retardation or 0 phase retardation. For example, a plurality of switchable units U simultaneously provides λ/4 phase retardation or 0 phase retardation, and thus an image is displayed or a mirror effect is provided. Certainly, in an embodiment, one or more of the switchable units U can provide λ/4 phase retardation and the others can provide 0 phase retardation, and thus the display simultaneously provides mirror area and image area at different regions corresponding to the switchable units U.

In the present embodiment, the mirror switchable organic light emitting display 1000′ has a plurality of switchable units U which are respectively switchable between λ/4 phase retardation and 0 phase retardation. Hence, the mirror switchable organic light emitting display 1000′ is switchable between an image display mode and a mirror mode, or simultaneously shows mirror area and image area at different regions. As a result, the application range of the mirror switchable organic light emitting display 1000′ is greatly extended, to satisfy the requirement of the customers for displays.

FIG. 5 is a schematic cross-sectional view illustrating a mirror switchable display according to an embodiment of the invention. The mirror switchable display 2000 includes an active light emitting display panel 1100, a switchable quarter-wave (λ/4) phase retardation panel 1200, a light transflective layer 1300, a light-transmissive material layer 1500, and a polarizing plate 1400.

The active light emitting display panel 1100 has a light output surface 1100a. In the present embodiment, the active light emitting display panel 1100 can include an organic light emitting display panel, a field emission display panel, a plasma display panel, and a liquid crystal display panel.

The switchable quarter-wave phase retardation panel 1200 has a first surface 1200a and a second surface 1200b, wherein the first surface 1200a faces the active light emitting display panel 1100. In the present embodiment, the switchable quarter-wave phase retardation panel 1200 is, for example, disposed at the light output surface 1100a of the active light emitting display panel 1100. The light transflective layer 1300 is disposed at the first surface 1200a of the quarter-wave phase retardation panel 1200 and faces the active light emitting display panel 1100. The light-transmissive material layer 1500 is disposed between the light transflective layer 1300 and the active light emitting display panel 1100. The polarizing plate 1400 is disposed on the second surface 1200b of the quarter-wave phase retardation panel 1200. The structures of the quarter-wave phase retardation panel 1200, the light transflective layer 1300, the light-transmissive material layer 1500, and the polarizing plate 1400 are similar to the structures of the quarter-wave phase retardation panel 200, 200′, the light transflective layer 300, the light-transmissive material layer 500, and the polarizing plate 400 described above, and thus can referred to those mentioned above and will not be reiterated herein.

In the present embodiment, the mirror switchable organic light emitting display 2000 has switchable quarter-wave phase retardation panel 1200 which can be switched between λ/4 phase retardation and zero phase retardation. Hence, the mirror switchable organic light emitting display 2000 is switchable between an image display mode and a mirror mode, or simultaneously shows mirror area and image area at different regions. Furthermore, in the image display mode, since the phase retardation panel can reduce the interference of the incident light to the display, the display has superior display effect. On the other hand, in the mirror mode, the light transflective layer disposed at a side surface of the phase retardation panel is able to increase the reflection of the incident light, and thus the display also has superior mirror effect. As a result, the application range of the mirror switchable organic light emitting display is greatly extended, to satisfy the requirement of the customers for display.

To sum up, the mirror switchable organic light emitting display and the mirror switchable display of the invention includes the display panel, the switchable quarter-wave phase retardation panel, the light transflective layer, and the polarizing plate. The switchable quarter-wave phase retardation panel is switchable between λ/4 phase retardation and zero phase retardation. Therefore, by using the switchable quarter-wave phase retardation panel with the polarizing plate and the light transflective layer, in the image display mode, the interference of the incident light to the display can be reduced with eliminating the reflection of the incident light at the surface of the display, and the display shows superior displayed image. On the other hand, in the mirror mode, the reflection of the incident light is increased, and thus the display also shows superior mirror reflection effect. In addition, since the light transflective layer is disposed at the first surface of the quarter-wave phase retardation panel, the reflection of the incident light is increased and the scattering of the incident light is reduced, and thus the display has improved mirror effect when in the mirror mode. Furthermore, according to an embodiment, the mirror switchable organic light emitting display has a plurality of switchable units, which are respectively switched between λ/4 phase retardation and zero phase retardation. Hence, the mirror switchable organic light emitting display is not only switchable between the image display mode and the mirror mode, but also simultaneously shows mirror area and image area at different regions. As a result, the application range of the mirror switchable organic light emitting display and the mirror switchable display is greatly extended, to satisfy the requirement of the customers for display.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A mirror switchable organic light emitting display comprising:
an organic light emitting display panel, having a light output surface;
a switchable quarter-wave (λ/4) phase retardation panel, disposed at the light output surface of the organic light emitting display panel, and having a first surface and a second surface, wherein the first surface faces the organic light emitting display panel;
a light transflective layer, disposed at the first surface of the quarter-wave phase retardation panel and facing the light output surface of the organic light emitting display panel; and
a polarizing plate, disposed on the second surface of the quarter-wave phase retardation panel.

2. The mirror switchable organic light emitting display as claimed in claim 1, wherein the organic light emitting display panel comprises:
a substrate;
a first electrode, disposed on the substrate;
a second electrode, disposed above the first electrode; and
an organic light emitting layer, disposed between the first electrode and the second electrode.

3. The mirror switchable organic light emitting display as claimed in claim 2, wherein the organic light emitting display panel further comprises a thin film transistor, disposed on the substrate and electrically connected to the first electrode.

4. The mirror switchable organic light emitting display as claimed in claim 2, wherein the organic light emitting display panel comprises a top emission organic light emitting display.

5. The mirror switchable organic light emitting display as claimed in claim 4, wherein a material of the second electrode comprises a transparent conductive material, and the second electrode is disposed at the light output surface of the organic light emitting layer.

6. The mirror switchable organic light emitting display as claimed in claim 4, wherein the second electrode does not entirely contact with the light transflective layer.

7. The mirror switchable organic light emitting display as claimed in claim 2, wherein the organic light emitting display panel comprises a bottom emission organic light emitting display.

8. The mirror switchable organic light emitting display as claimed in claim 7, wherein a material of the first electrode comprises a transparent conductive material, and the first electrode is disposed at the light output surface of the organic light emitting layer.

9. The mirror switchable organic light emitting display as claimed in claim 1, wherein the switchable quarter-wave phase retardation panel comprises:
a first transparent substrate;
a second transparent substrate, disposed opposite to the first transparent substrate;
a liquid crystal layer, disposed between the first transparent substrate and the second transparent substrate;
a first conductive layer, disposed on the first transparent substrate and between the first transparent substrate and the liquid crystal layer; and
a second conductive layer, disposed on the second transparent substrate and between the second transparent substrate and the liquid crystal layer.

10. The mirror switchable organic light emitting display as claimed in claim 9, wherein a material of the first conductive layer and the second conductive layer comprises a transparent conductive material.

11. The mirror switchable organic light emitting display as claimed in claim 9, wherein a material of the first conductive layer and the second conductive layer comprises indium tin oxide (ITO), indium zinc oxide (IZO), aluminum zinc oxide (AZO), or a combination thereof.

12. The mirror switchable organic light emitting display as claimed in claim 9, wherein the switchable quarter-wave phase retardation panel further comprises an active device, disposed on the first transparent substrate and electrically connected to the first conductive layer.

13. The mirror switchable organic light emitting display as claimed in claim 9, wherein the switchable quarter-wave phase retardation panel comprises a plurality of switchable regions.

14. The mirror switchable organic light emitting display as claimed in claim 1, wherein the switchable quarter-wave phase retardation panel is switchable between λ/4 phase and 0 phase.

15. The mirror switchable organic light emitting display as claimed in claim 1, wherein the polarizing plate comprises a linear polarizing plate.

16. The mirror switchable organic light emitting display as claimed in claim 1, wherein a material of the light transflective layer comprises aluminum, silver, platinum, copper, or gold.

17. The mirror switchable organic light emitting display as claimed in claim 1, wherein a thickness of the light transflective layer ranges from 1 to 1000 nm.

18. The mirror switchable organic light emitting display as claimed in claim 1 further comprising a light-transmissive material layer disposed between the light transflective layer and the organic light emitting display panel.

19. A mirror switchable display comprising:
an active light emitting display panel, having a light output surface;
a switchable quarter-wave phase (λ/4) retardation panel, having a first surface and a second surface, wherein the first surface faces the active light emitting display panel;
a light transflective layer, disposed at the first surface of the quarter-wave phase retardation panel and facing the active light emitting display panel; and
a polarizing plate, disposed on the second surface of the quarter-wave phase retardation panel.

20. The switchable three-dimensional display as claimed in claim 19, wherein the active light emitting display panel comprises an organic light emitting display panel, a field emission display panel, a plasma display panel, and a liquid crystal display panel.
